(19) United States
(12) Patent Application Publication
(10) Pub. No.: US 2008/0110313 A1
(43) Pub. Date: May 15, 2008

(54) FLAT-BED SHEET PUNCHING MACHINE

(75) Inventors: Thomas IMKAMP, Dusseldorf (DE); Peter PALMEN, Monchengladbach (DE); Frank SCHMID, Krefeld (DE)

Correspondence Address: HEIDELBERGER DRUCKSMASCHINEN AKTIENGESELISCHAFT;C/O KEATING & BENNETT, LLP, 8180 GREENSBORO DRIVE, SUITE 850, MCLEAN, VA, 22102, US

(73) Assignee: HEIDELBERGER DRUCKMASCHINEN AG, Heidelberg (DE)

(21) Appl. No.: 11/935,591

(22) Filed: Nov. 6, 2007

(30) Foreign Application Priority Data
Nov. 14, 2006 (DE) 10 2006 053 577.4

(51) Int. Cl. B26F 1/40; B26D 7/27; B26D 7/00

(52) U.S. Cl. 83/277

(57) ABSTRACT

A flat-bed sheet punching apparatus includes at least two flat-bed sheet punching machines each having at least one punching mechanism, wherein the at least two flat-bed sheet punching machines are arranged opposite to each other and with an attendant space therebetween such that the at least two flat-bed sheet punching machines can be attended from the attendant space between the at least two flat-bed sheet punching machines.

### BACKGROUND OF THE INVENTION

1. Field of the Invention

The present invention concerns a flat-bed sheet punching layout with two flat-bed sheet punching machines, each having at least one punching mechanism.

2. Description of the Related Art

Punching refers to a cutting with closed, geometrical forms, which can be circular, oval, or polygonal, as well as special shapes of every kind. Practices in the post-processing of a print job, such as punching with a hollow punch, rounding corners, and register punching, are also included in this field. The punching is done against a base or against a punch, and sometimes there are also shearing processes (cf. Post-Processing, Training Manual for Bookbinders, Bundesverband Druck e.V. 1996, page 351 et seq.).

Packaging materials of paper, cardboard, paperboard or corrugated cardboard are primarily punched in sheet format. During the punching process, however, crease lines or blind imprints may also be introduced into the finished sheets. This complex process makes it essential to punch the sheets individually. Since the end products are packages with demanding technical and graphical requirements (such as those for cosmetics, cigarettes, medicines, foods, etc.), special requirements are placed not only on the packaging materials themselves, but also punching dies with minimal tolerances and extremely precise and reliable punching machines are required for optimal results.

These demands are best met by flat bed punches. The printed sheets, stacked on a pallet, are fed to the punch. In the machine, the sheets being punched are first singled out, then oriented accurately in an orienting mechanism, picked up by a gripping cart and positioned exactly in the punching mechanism between a stationary bottom table and a top table which can move vertically via a crank or eccentric gearing. One such flat-bed punch is known, for example, from DE 30 44 083 A1.

The two tables are outfitted with cutting and creasing dies or corresponding mating dies, with which the finished copies are punched out from the sheets feed at a timed rate between the table surfaces and at the same time the creases needed for a clean folding are imprinted. In the following breaker station, the wastes are removed mechanically by breaker dies. Depending on the configuration of the machine, the punched copies can finally be separated in a specially provided copy separation mechanism.

The known flat-bed sheet punching machines are relatively cost-intensive in terms of attendance and fitting up.

### SUMMARY OF THE INVENTION

In order to overcome the problems described above, preferred embodiments of the present invention provide a flat-bed sheet punching layout which can be attended and maintained with minimal expense.

According to a preferred embodiment of the present invention, two flat-bed sheet punching machines are arranged opposite to each other and with a spacing therebetween such that the two flat-bed sheet punching machines can be attended from the attendance space formed between the flat-bed sheet punching machines.

In a preferred embodiment, two flat-bed sheet punching machines are arranged in the manner of a twin layout opposite to each other in mirror image, so that both machines can be attended and maintained in common by a single attendant. This makes the attendance and maintenance more economical. Furthermore, space is saved, since there needs to be only one attendance space or attendance platform for two punching machines. Thanks to the mirror image layout, it is optimally possible to load the dies from the drive end.

Furthermore, it is advantageously possible to set up several mirror-image twin layouts alongside each other. In this configuration, the feed units can then load material into the punches arranged alongside each other using common loading logistics and/or the output units can be jointly loaded with empty pallets and/or the output units can be serviced by common logistics.

Furthermore, it is advantageously possible in a mirror-image layout of the punches to make common use of disposal mechanisms for the breaker station and/or marginal strips, as well as the shredder. In general, moreover, all accessory mechanisms can be used in common at the attendance platform, such as viewing table, die fixtures, etc.

In another advantageous preferred embodiment, a joint use of operating data acquisition terminals is possible.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 shows a flat-bed sheet punching layout according to a preferred embodiment of the present invention in schematic top view.

FIG. 2 shows a flat-bed sheet punch of the layout from FIG. 1 in schematic side view.

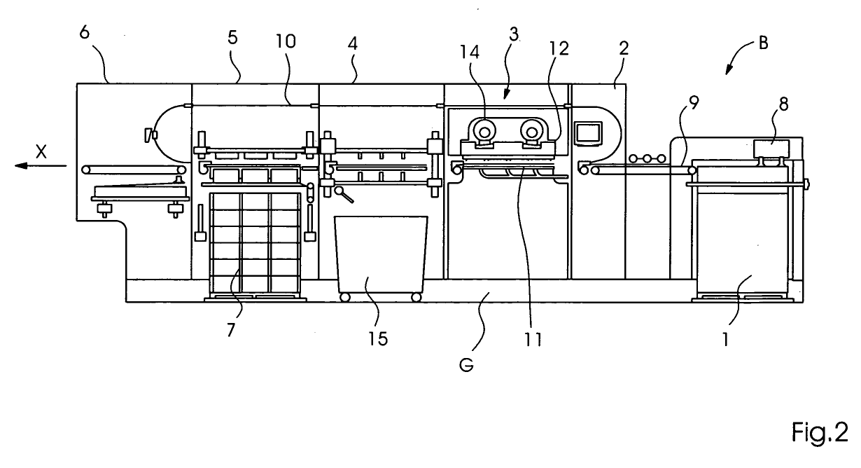

### DETAILED DESCRIPTION OF PREFERRED EMBODIMENTS

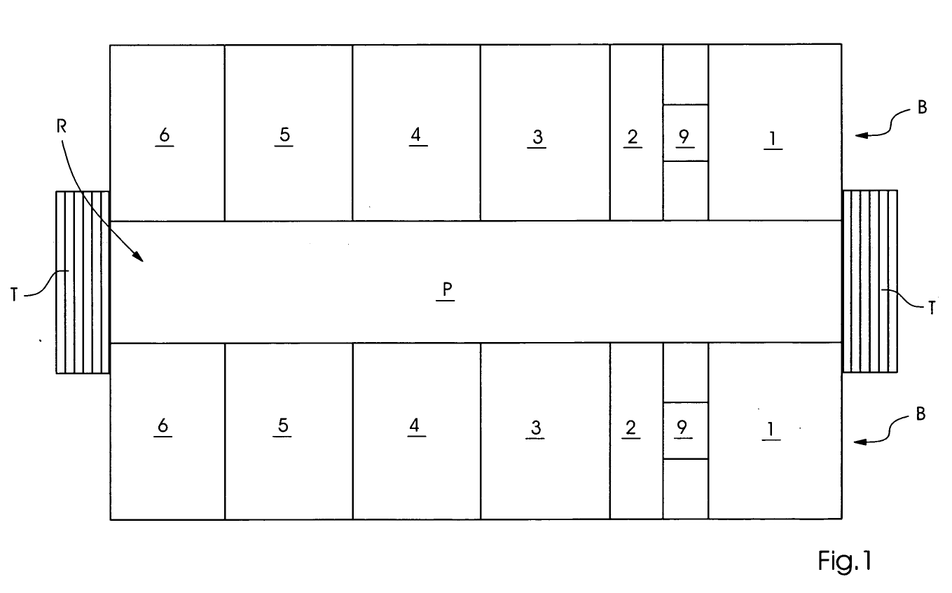

FIG. 1 shows a flat-bed sheet punching layout preferably including two flat-bed sheet punching machines which serve to process sheet-like materials of paper, cardboard and the like by punching and/or embossing, and in particular, they can be used in the production of paper or cardboard blanks. Each of the flat-bed sheet punching machines B preferably includes, lying one behind the other in the run-through direction X, a feeding and singling mechanism 1, an orienting mechanism 2, a punching mechanism 3, a breaking mechanism 4, a finished copy output mechanism 5 and a separate sheet feed mechanism 6. Furthermore, a pallet station 7 is provided at the finished copy output mechanism 5.

As is especially evident from FIG. 1, the two flat-bed sheet punching machines B are arranged opposite to each other in mirror image, while in the space R between the two punching machines B there is provided a platform P, by which both punching machines B can be attended at the same time. The platform P can be mounted by stairs T at both ends. This twin layout produces the benefit that only a single attendant is needed to attend and maintain both punching machines B. This lowers the labor costs.

In the feeding and singling mechanism 1, the sheets being processed are stacked and individually removed from the stack by a suction head 8 and placed on a transport belt 9, which takes the sheet to the orienting mechanism 2, where it is oriented precisely by side and front marks at three points, for example.

When working with endless webs, a roll-off mechanism, possibly with cross cutters downstream from it, is used in place of the feeding mechanism 1.

In the orienting station 2, the oriented sheet is taken up by a grip of a transport system, of which only the transport chain 10 is shown in the drawing, which takes the sheet through the further processing stations 3, 4, 5, 6, timed and oriented precisely.

After the orienting station 2 comes the punching mechanism 3, having a lower table 11 firmly mounted on the machine frame G and a vertically movable upper table 12. The upper table 12 carries a punching blade and the lower table a counterplate.

The activation of the upper table 12 occurs in usual manner by an eccentric gearing 14, which is connected by a search rod gearing (not shown) to a central drive of the punching machine, which also drives the further processing stations.

Following the punching mechanism 3 is the breaker mechanism 4, in which the remnant scraps produced by the punching process and no longer needed are pushed downward from the sheet, so that these scraps drop into a container-like cart 15 pushed in underneath the breaker mechanism 4.

After the breaker mechanism 4 comes the output mechanism 5, in which the sheet is either simply laid on a stack or at the same time separated into finished copies, for which one can use separating dies of a kind not further depicted here. The sheets can be laid here on pallets and stacked up. The pallets are situated in the pallet station 7, so that after reaching a certain stack height the pallet with the stacked sheets can be driven away from the zone of the punching machine.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A flat-bed sheet punching apparatus comprising:
at least two flat-bed sheet punching machines each including at least one punching mechanism; wherein
the at least two flat-bed sheet punching machines are arranged opposite to each other and with an attendant space therebetween such that the at least two flat-bed sheet punching machines are arranged to be attended from the attendant space between the at least two flat-bed sheet punching machines.

2. The flat-bed sheet punching apparatus according to claim 1, further comprising an attendance platform provided in the attendant space on which an attendant can move around.

3. The flat-bed sheet punching apparatus according to claim 1, wherein the at least two flat-bed sheet punching machines are arranged opposite to each other in mirror image.

4. The flat-bed sheet punching apparatus according to claim 1, wherein the at least two flat-bed sheet punching machines are jointly connected to an operating data acquisition terminal.
